(19) United States
(12) Patent Application Publication
(10) Pub. No.: US 2018/0012158 A1
(43) Pub. Date: Jan. 11, 2018

(54) Increasing the Expected Availability of Fast-Delivery Offers to Customers

(71) Applicants: Pawel M. Cholewinski, Kirkland, WA (US); Xiao Yu Li, Seattle, WA (US); Kalyanaraman Prasad, Seattle, WA (US)

(72) Inventors: Pawel M. Cholewinski, Kirkland, WA (US); Xiao Yu Li, Seattle, WA (US); Kalyanaraman Prasad, Seattle, WA (US)

(21) Appl. No.: 12/981,376

(22) Filed: Dec. 29, 2010

(51) Int. Cl. G06Q 10/06; G06Q 30/06; G06Q 10/08

(52) U.S. Cl. CPC G06Q 10/0633; G06Q 10/08; G06Q 30/06

(57) ABSTRACT

A method and system for increasing the expected availability of fast-delivery offers to customers. A method may include identifying a total number of units of a plurality of items to be stored in one or more fulfillment centers. In some cases, the items may be a product or a group of products. The method may also include receiving an order forecast of expected orders for each of the plurality of items and determining, for each of the plurality of items, a portion of the expected orders that is expected to be fulfilled by the one or more fulfillment centers. The method may then include calculating based, at least in part, on the total number of units, the order forecast, and the portion of the expected orders, a target inventory of each of the plurality of items that increases an expected availability of a given delivery offer to future customers.

### BACKGROUND

To provide a wide selection of products that are readily available for delivery, many merchants (whether engaging in electronic or conventional “brick and mortar” commerce) may store those products in warehouses, fulfillment centers, or other inventory facilities. Keeping items in inventory may provide numerous benefits, such as, for example, accommodating variations in customer demand and/or a manufacturer or distributor's ability to supply those items. Typically, holding some quantities of a particular product “in stock” may enable a merchant to make such product available to customers in a more consistent fashion.

However, to maintain products in stock, a merchant incurs certain costs. Some of these costs may include, for example, real estate costs (e.g., lease costs, debt service, etc.), personnel costs, and facilities costs (e.g., utilities, maintenance, etc.). There may also be capital or economic costs related to the money that a merchant paid its vendor to obtain a stored product, which is then committed to inventory until payment for that product is received from a customer. Other types of costs may further include loss or damage due to accidents, or the like.

Balancing the benefits of keeping inventory with its associated costs often presents complex planning issues. And the harmonization of these various costs and benefits may be obtained with in-stock optimization mechanisms.

### BRIEF DESCRIPTION OF THE DRAWINGS

FIG. 1 is a block diagram of a fulfillment center according to some embodiments.

FIG. 2 is a block diagram of a system configured to receive customer orders and perform fulfillment and inventory planning according to some embodiments.

FIG. 3 is a block diagram of a fulfillment network operated by a merchant according to some embodiments.

FIG. 4 is a flow diagram of a method for setting inventory levels to increase the expected availability of fast-delivery offers according to some embodiments.

FIG. 5 is a block diagram illustrating a computer system configured to implement an order fulfillment system according to some embodiments.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS

Various embodiments of systems and methods for increasing the expected availability of fast-delivery offers to customers are disclosed. In some embodiments, the systems and methods described herein may allow a merchant to set inventory targets for items to be stored in a fulfillment center in such a way that those targets increase (or maximize) the number of fast-delivery offers that may be made to expected customers. To this end, an optimization formulation is derived whose solution maximizes the expected value of fast-delivery offers presented to customers in a given region.

According to some embodiments, a method may include identifying a total number of units of a plurality of items to be stored in one or more fulfillment centers located within a geographic region. The method may also include receiving a demand forecast of expected orders for each of the plurality of items, where the expected orders are expected to specify delivery addresses within the geographic region. The method may further include determining, for each of the plurality of items, a portion of the expected orders that is expected to be fulfilled by the one or more fulfillment centers. In addition, the method may include calculating based, at least in part, on the total number of units, the forecast, and the portion of the expected orders, a target inventory of each of the plurality of items for the one or more fulfillment centers that increases an expected availability of a given delivery offer to customers of the plurality of items, where the given delivery offer cannot be designated for fulfillment by a fulfillment center located outside of the geographic region.

As used herein, the term “merchant” includes any entity capable of conducting and/or fulfilling a sales transaction in response to an actual or expected order or request. Typically, a merchant may present or offer various products or items to its customers, as well as information about those items (e.g., availability and pricing information, product details, images, etc.) that facilitate a sale. For example, a retail enterprise that generally sells merchandise to end consumers (e.g., not generally intended for resale as new) may sell through an online, web-based channel that may include an online catalog or portal configured to display information about items or products, a web-based order entry system such as a virtual shopping cart or other system, a status tracking tool through which customers may track the status or progress of orders, a search engine, and any of a number of other features suitable for promoting and performing sales transactions. Merchants may also engage in transactions using other types of sales channels. For example, a merchant may employ a mail-order catalog channel, where customers may receive information about items or products via a mailed catalog and make orders using paper forms and/or via telephone. Additionally or alternatively, a merchant may have a physical (i.e., “brick-and-mortar”) store, through which customers may receive information about products and order or purchase those products in person.

As used herein, the term “customer” includes any purchaser (or potential purchaser) of an item or product, including entities other than an end consumer of a product sold. Therefore, manufacturers, distributors, retailers, and consumers may be “merchants” and/or “customers” depending upon their position within the supply chain. It is noted that in some embodiments, a unit of an item may be rented, leased or licensed to a customer under specific terms in exchange for revenue or other economic consideration.

As used herein, the term “sale” includes any suitable transaction involving an item resulting in either direct or indirect (e.g., imputed or tangential) revenue, and is intended to encompass rentals, leases, subscriptions, licenses, and other types of revenue models.

As used herein, the term “fulfillment center” includes any inventory storage facility such as, for example, warehouses, repositories, depositories, stockrooms, storehouses, distribution centers, material handling facilities, or the like.

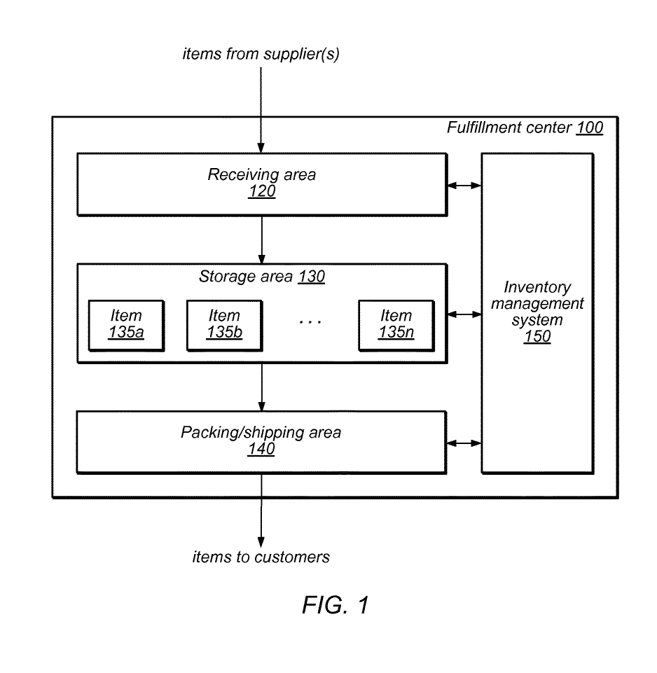

In order to offer its customers a wider variety of items that are readily available for delivery, a merchant may store various quantities of such items within one or more fulfillment centers. An embodiment of one such fulfillment center is shown in FIG. 1. As illustrated, fulfillment center 100 includes receiving area 120, storage area 130 configured to store an arbitrary number of items or products 135a-n, and packing/shipping area 140. The arrangement of the various areas within the illustrated embodiment of fulfillment center 100 is depicted functionally rather than schematically. For example, in some embodiments, it is noted that multiple different receiving areas 120, storage areas 130, and packing/shipping areas 140 may be interspersed rather than segregated. Additionally, fulfillment center 100 includes an inventory management system 150 configured to interact with each of receiving area 120, storage area 130 and packing/shipping area 140.

Fulfillment center 100 may be configured to receive different kinds of items 135 from various suppliers and to store them until a customer order specifying particular ones of items 135 is received. The particular items 135 may then be selected from storage and sent to the customer. The general flow of items through fulfillment center 100 is indicated using arrows. Specifically, in the illustrated embodiment, items 135 may be received from one or more suppliers, such as manufacturers, distributors, wholesalers, etc. at receiving area 120. In various embodiments, items 135 may include merchandise, commodities, perishables, or any suitable type of item depending on the nature of the merchant or enterprise that operates fulfillment center 100. Upon being received from a supplier at receiving area 120, items 135 may be prepared for storage. For example, in some embodiments items 135 may be unpacked or otherwise rearranged, and inventory management system 150 (which, as described below, may include one or more software applications executing on a computer system) may be updated to reflect the type, quantity, condition, cost or any other suitable parameters with respect to newly received items 135. It is noted that items 135 may be stocked, managed or dispensed in terms of countable, individual units or multiples of units, such as packages, cartons, crates, pallets or other suitable aggregations. Alternatively, some items 135 such as bulk products, commodities, etc. may be stored in continuous or arbitrarily divisible amounts that may not be inherently organized into countable units. Such items 135 may be managed in terms of measurable quantities such as units of length, area, volume, weight, time duration or other dimensional properties characterized by units of measurement. Generally speaking, a quantity of an item 135 may refer to either a countable number of individual or aggregate units of an item 135 or a measurable amount of an item 135, as appropriate.

After arriving through receiving area 120, items 135 may be stored within storage area 130. In some embodiments, like items 135 may be stored together in bins, on shelves or via other suitable storage mechanisms, such that all items 135 of a given kind are stored in one location. For example, items having a common Universal Product Code (UPC), Stock-Keeping Unit (SKU) code, or other designation (including proprietary designations) may be stored together. In other embodiments, like items 135 may be stored in different locations. For example, to optimize retrieval of certain items 135 having high turnover within a large physical facility, those items 135 may be stored in several different locations to reduce congestion that might occur at a single point of storage.

When a customer order specifying one or more of items 135 is received, the corresponding items 135 may be selected or “picked” from storage area 130. In various embodiments, item picking may range from minimally automated to completely automated picking. For example, in one embodiment fulfillment center employees may pick items 135 using written or electronic pick lists derived from customer orders, while in another embodiment conveyor belts and robotics may be used to pick and transfer items 135. After the items 135 corresponding to a particular order are picked, they may be processed at packing/shipping area 140 for shipment to the customer. For example, items may be packaged for shipment to the customer using a common carrier, or simply bagged or otherwise prepared for direct transfer to a customer, e.g., at an order pickup counter. In some embodiments, further interaction with inventory management system 150 may occur when items 135 are picked from storage area 130 and/or processed at packing/shipping area 140, for example to update inventory records to reflect the removal of inventory, to record revenue for the sale or other transaction (e.g., lease, rental, exchange, etc.) and so forth.

Management of items 135 stored as inventory within fulfillment center 100 often presents complex optimization issues. Generally speaking, the level of inventory of a given item 135 may affect the quality of service associated with providing the given item to a customer. Quality of service may encompass factors such as general availability and selection of items 135, timeliness of order completion, or any other factors relevant to a customer's perceived experience in conducting business relating to items 135. As an example of the interaction between inventory levels and quality of service, if a particular item 135 ordered by a customer is not in stock within fulfillment center 100, the customer may be forced to wait for delivery until that particular item 135 can be obtained, or the customer may cancel the order resulting in a lost sale. Consequently, keeping a number of units of items 135 on hand may assist in the timely fulfillment of orders and increase customer satisfaction. A larger inventory, for example, may more readily accommodate unexpected increases in customer demand.

On the other hand, various costs are typically associated with storing items 135 in fulfillment center 100 for any period of time. In some embodiments, holding a unit of an item 135 in storage within storage area 130 may incur incremental storage costs. For example, the cost of providing fulfillment center 100 in which items 135 may be stored may include recurring real estate costs (e.g., lease costs, debt service, etc.), personnel costs, facilities costs (e.g., utilities, maintenance, etc.) and any other costs associated with fulfillment center 100. In addition to storage costs, in some embodiments, holding a unit of an item 135 in storage may incur capital or economic costs related to the price paid to obtain the item. That is, once working capital or cash flow is committed to a unit of an item 135 (e.g., once that unit is paid for), that economic value is not available for other purposes; the committed value is “tied up” in the corresponding inventory. Other types of costs may also be associated with holding units of items 135 in storage. For example, in the ordinary course of operation of fulfillment center 100, items 135 may be subject to loss or damage due to accidents or mishaps. A rate of loss, or a corresponding rate of insurance against such loss, may be included within an overall cost of holding a unit of an item 135. Also, over time, items 135 may depreciate, expire, spoil or become obsolete, which may also be expressed as part of a cost of holding such items 135. At least in part to avoid or minimize some of these various costs, it is common practice for a merchant to fulfill existing orders for items 135 as soon as those orders are received and processed.

A merchant that deals with customers on a large scale may not adequately meet its business goals with only a single fulfillment center 100. For example, a merchant that deals in many different types of items 135 and/or that services customers in a large geographical region may find it impractical to keep its entire inventory in one facility. In some instances, a merchant that faces the challenge of scaling its inventory and fulfillment handling capabilities may choose to deploy a more complex fulfillment network. To address these challenges, the merchant may implement an order fulfillment and inventory planning system or the like.

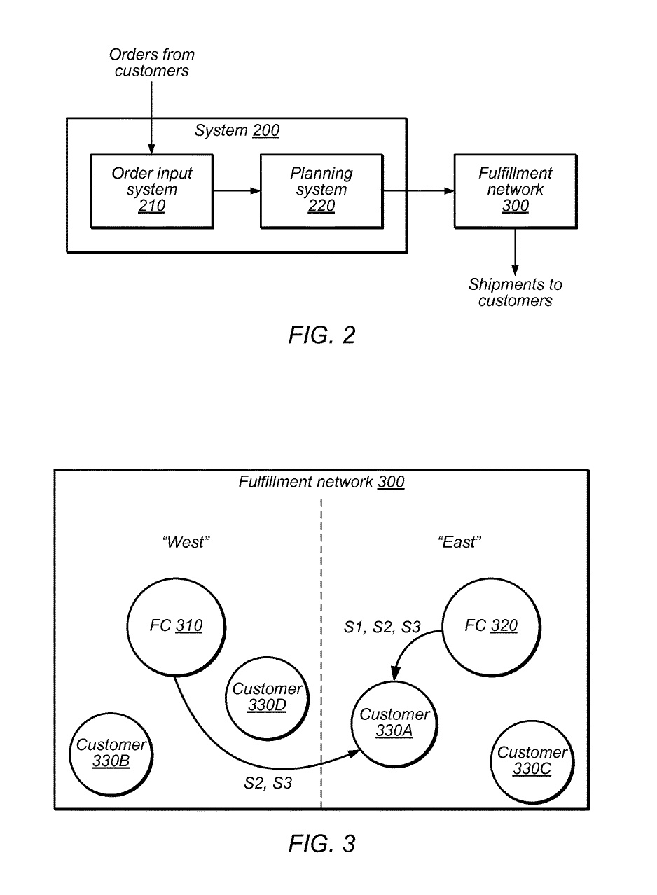

FIG. 2 illustrates an embodiment of a system configured to receive customer orders and perform fulfillment and inventory planning according to some embodiments. Specifically, system 200 may be configured to receive customer orders for items 135, determine how customer orders should be assigned to the resources of network 300 for fulfillment, and dispatch instructions to the assigned resources of network 300 in order to effect shipment of customer orders. In addition, system 200 may also be configured to determine set inventory targets for items stored in a fulfillment center in such a way that those targets increase (or maximize) the number of fast-delivery offers that may be made to expected customers. In some embodiments, system 200 may also determine whether to store such items in the fulfillment center. To this end, system 200 may implement an optimization formulation whose solution maximizes the expected value of fast-delivery offers presented to customers in a given region. In the illustrated embodiment, system 200 includes an order input system 210 that is configured to communicate with a fulfillment and inventory planning system 220, which is in turn configured to communicate with network 300.

Generally speaking, order input system 210 may be configured to receive orders placed by customers for various items 135 offered by the merchant. In some embodiments, order input system 210 may be configured to implement an electronic commerce (e-commerce) portal, such as a web-based interface through which customers may browse items 135, select items 135 for ordering, and supply details regarding orders (e.g., payment information, shipping address information, etc.). In other embodiments, order input system 210 may be configured to implement an order entry interface that is not presented, to the customer directly, but which is instead employed by an agent (e.g., a salesperson, customer service representative, etc.) to input order information on behalf of a customer.

Planning system 220 may generally be configured to receive incoming orders received by the merchant via order input system 210 and to analyze customer orders to determine how they should be assigned to various fulfillment centers of network 300 for fulfillment. For example, if a given customer orders five distinct items 135, it may be possible to ship all of the ordered items 135 from a single fulfillment center 100. However, it may also be possible to divide the given customer's order for fulfillment by multiple different fulfillment centers 100. As discussed below, numerous different variables and constraints may be taken into account by planning system 220 when generating a fulfillment plan for an order, such as the costs associated with various plans, the promises made to the customer regarding shipping or arrival dates, or other factors.

After identifying the fulfillment plan that should be executed for a particular order, fulfillment and inventory planning system 220 may be configured to communicate instructions to network 300 in order to realize the plan. For example, fulfillment and inventory planning system 220 may interact with the inventory management system 150 of a fulfillment center 100 corresponding to a particular fulfillment center to instruct that certain items 135 of a particular order should be picked, packed, and shipped to the customer for the particular order. Alternatively, planning system 220 may interact with a drop shipper, such as a third party merchant or distributor, to instruct that certain items 135 of a particular order should be shipped to the customer. In various embodiments, communication of fulfillment instructions that are needed to implement a particular fulfillment plan to the various fulfillment centers 100 within network 300 may occur according to any suitable technique. For example, planning system 220 may be configured to exchange messages with systems within a particular fulfillment center using web-based protocols (e.g., Hypertext Transfer Protocol (HTTP), eXtensible Markup Language (XML), or other suitable protocols) conveyed via the public Internet, a private intranet, Virtual Private Networks, or another suitable networking scheme or combination of these. Communication between planning system 220 and fulfillment centers may also be implemented using electronic mail or other messaging techniques, analog or digital telephony, or any other wired or wireless data transfer technique, either using standard or proprietary protocols.

In addition, planning system 220 may also be configured to determine set inventory targets for items stored in one or more fulfillment centers of network 300 in such a way that those targets increase (or maximize) the number of fast-delivery offers that may be made to expected customers.

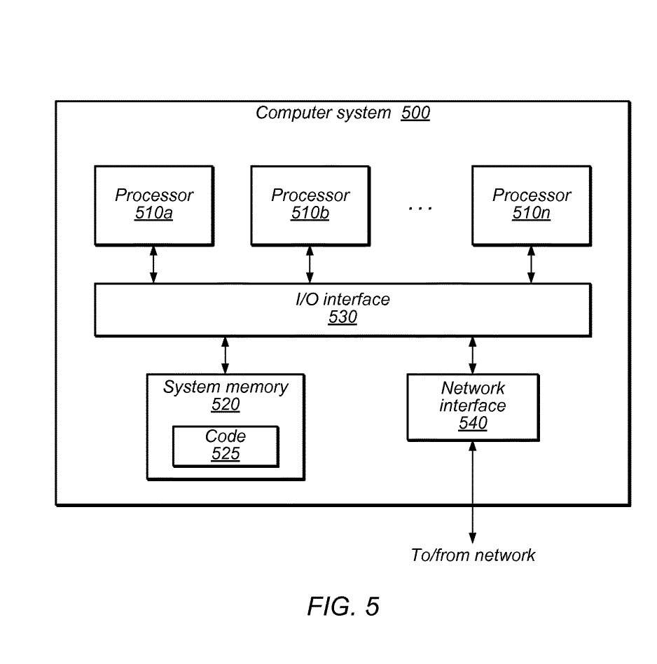

In various embodiments, order input system 210 and planning system 220 may be implemented as respective dedicated computer systems, or they may be implemented as computer-executable instructions and data that may be executed by one or more computer systems (e.g., as described in greater detail below with respect to FIG. 5). Systems 210 and 220 are discussed and shown as separate systems in order to facilitate their description; however, in some embodiments, the functions of these systems may be integrated into and implemented by a single computer system or set of computer-executable instructions. Alternatively, the functionality of systems 210 and 220 may be partitioned differently than is shown in FIG. 2. For example, some functions of these systems may be assigned to or subsumed within the operation of other systems.

Additionally, it is contemplated that order input system 210 and/or planning system 220 may interact with or implement various features of a number of other features not shown. For example, in one embodiment, order input system 210 may be configured to interact with accounting and billing systems in order to collect customer payments and update enterprise financial records to reflect the effects of transactions. In one embodiment, planning system 220 may be configured to interact with additional systems that track the current state of inventory within network 300 and/or predict its future state (e.g., by predicting lead time for various items 135, accounting for items 135 that are inbound to network 300 but not yet received by fulfillment centers, or analyzing or predicting other network state variables). Planning system 220 may also interact with other systems that model or estimate variables that may influence the planning process, such as the expected transit time for shipping from a particular fulfillment center to a customer via a particular carrier and/or shipping method.

As noted above, a merchant may operate or otherwise have at its disposal a fulfillment network that includes a number of individual fulfillment centers distributed across a wide geographic area (e.g., North America). Turning now to FIG. 3, a diagram of fulfillment network 300 is depicted according to some embodiments. As illustrated, fulfillment network 300 includes two regions: “East” and “West.” Each region includes at least one fulfillment center, and each of fulfillment centers 310 and/or 320 may be similar to fulfillment center 100 described above with respect to FIG. 1. Moreover, a plurality of customers 330A-D may be distributed among the various regions in any manner. As illustrated, customers 330A and 330C are located within the East region, whereas customers 330B and 330D are located within the West region.

Although fulfillment network 300 is shown with two regions, other embodiments are not limited to this particular configuration and may include any suitable number of regions. Similarly, although each region is shown as having a fulfillment center, in other embodiments each region may include any number of fulfillment center “clusters,” each cluster having any number of fulfillment centers or “nodes.” In some embodiments, fulfillment network 300 may span an entire state, country, continent, or the world. Further, each region (e.g., “East,” “West,” etc.) may represent a geographical area encompassing delivery addresses to which shipping or delivery costs are similar (e.g., costs within $0.05, $0.10, $0.25, $1.00 or some other specified amount of each other). As such, in some cases, “regions” need not be adjacent and/or contiguous with respect to each other (e.g., there may be one or more “islands” within the “East” region that addresses with same shipping costs as the “West” region and vice versa). Furthermore, although fulfillment centers 310 and/or 320 are shown as being “within” the West and East regions, respectively, in some cases a particular fulfillment center may be outside of a given geographic region but may nonetheless be assigned to that region. In general, the granularity with which regions covered by a given fulfillment network are defined may depend on data available for making similar-shipping-cost determinations and/or on the level of precision desired by the merchant.

Still referring to FIG. 3, customer 330A may place one or more orders with the merchant for one or more units of one or more items. For simplicity of explanation, however, let us consider a situation where customer 330A places one order for one unit of one item. The order may be placed online (i.e., with a computer device connected to the Internet), via a mail-in form, via a telephone, in-person, or in any other suitable manner. In the case of an online order, that order may be received, for example, by order input system 210 shown in FIG. 2. The customer may select the item for purchase and add it item to a virtual “shopping cart.” During a “checkout” procedure, the customer may provide billing and/or shipping address information to the merchant, as well as specify shipping/delivery options for the item, such as, for example, same-day delivery, next-day delivery, two-day delivery, 3-5 business days, 5-8 business days, etc.

During the “checkout” phase or process, the merchant may determine whether certain types of delivery are available for the item, and may therefore be offered to the customer. For example, very large appliances (even if presently in-stock) or custom-made products may not be available for delivery any sooner than 5-8 business days. On the other hands, tickets to a sports event that will take place in 2 days would need to be delivered in less than 5-8 business days. Accordingly, in some embodiments, the checkout process may only make available to the customer the delivery options that can actually be fulfilled. For example, in the case of a custom-made product, “same-day delivery” may not be displayed to the customer. On the other hand, in sports event example, only same-day and/or next-day delivery may be offered.

In general, if the fulfillment center (or cluster of fulfillment centers) that is closest to the address to which the item will be shipped has run out-of-stock of that item, it may not be possible or it may be cost-prohibitive to have a more distant fulfillment center (or cluster of fulfillment centers) fulfill a “fast-delivery” request. In other words, the more distant fulfillment center cannot ordinarily be designated to fulfill the order. Accordingly, in most instances, if a fulfillment center runs out stock for an ordered item, a local customer seeking to purchase that item may not be offered a fast-delivery option during checkout.

Examples of “fast-delivery” may include same-day-delivery, time-window-delivery (e.g., same day and between the hours of 9:00 a.m. and 12:00 p.m., or some other specified time window), or any other type of delivery that can only be reasonably fulfilled by the fulfillment center (or the cluster of fulfillment centers) closest to the specified delivery address. Conversely, “slow-delivery” may include any type of delivery (e.g., 5-8 business days, priority mail, etc.) that may be reasonably fulfilled by another fulfillment center (or cluster of fulfillment centers) that is more distant from the delivery address than the closest fulfillment center (or cluster of fulfillment centers).

Once the order is completed, the merchant may have an opportunity to make decisions as to how to fulfill the order (e.g., which of fulfillment centers 310 or 320 will the item ship from, etc.). Referring to FIG. 3, as between fulfillment centers 310 and 320, it is apparent that customer 330A is located closest to fulfillment center 320—i.e., in the East region. (In fact, however, customer 330A may be located anywhere, but his or her order specifies a delivery address in the East region.) Moreover, as illustrated, three shipping options are assumed possible: S1 (e.g., same-day delivery), S2 (e.g., next-day delivery), and S3 (e.g., two-day delivery). Because fulfillment center 320 is closest to customer 330A, it is capable of fulfilling the order using any of three shipping options. Further, because fulfillment center 310 is distant from customer 330A, it is only capable of fulfilling the order using the “slower” delivery options, that is, S2 and S3. Therefore, in some cases, there may be one or more shipping options (e.g., S1 or same-day delivery) that can only be fulfilled by fulfillment centers or regions that are local with respect to a given delivery address.

Accordingly, if the shipping or delivery option selected by the customer is “fast” (e.g., same-day-delivery), then it is likely that fulfillment centers outside of the East region cannot be designated to fulfill the order, or at least would not be so designated in the ordinary course of the merchant's business (e.g., it may not possible to find a delivery service capable of delivering with the available notice or it may be extraordinarily expensive to fulfill the order). Hence, the order will have to be fulfilled by the fulfillment center that is closest to customer 330A—i.e., fulfillment center 320—assuming, of course, that such fulfillment center has the item in stock. In some situations, if the selected shipping or delivery option is a “slower” one (e.g., 5-8 business days), then the merchant may decide it is more advantageous to fulfill the order from a distant fulfillment center (e.g., fulfillment center 310), even if local fulfillment center 320 also has the ordered item in-stock.

Let us assume, in the scenario described above, that fulfillment center 320 has the item in-stock. In this case; the merchant is in fact capable of offering same-day-delivery (or some other type of fast-delivery option) to customer 330A. However, despite being offered same-day-delivery, assume that customer 330A instead selects a slow-delivery option (e.g., 3-5 business days). Also assume that, in light of customer 330A's slow-delivery selection, the merchant determines that it should fulfill the order from fulfillment center 310, as illustrated by the arrow connecting fulfillment center 310 to customer 330A. As a result, the same unit of the same item in stock at fulfillment center 320 that allowed the merchant to make a fast-delivery offer to the present customer may still be used to make another fast-delivery offer to a future, expected customer. In other words, there are situations where the same unit of the same item may be used more than once to trigger a fast-delivery offer.

In some embodiments, systems and methods described herein may allow the merchant to set inventory target values for items stored in a one or more fulfillment center s in such a way that those values increase (or maximize) the number of fast-delivery offers that will be made available to expected customers. In other embodiments when a plurality of fulfillment centers (e.g., a cluster) is assigned to a particular geographic region, systems and methods described herein may provide inventory targets for the entire region. Once the cluster-based allocation has been calculated, target inventory quantities may then be apportioned among the plurality of fulfillment centers of that region in any suitable way (e.g., equally divided among the fulfillment centers, distributed to satisfy another storage or purchase constraint of each center, etc.).

In the paragraphs that follow, an optimization formulation is derived whose solution maximizes the expected value of fast delivery offers presented to customers in a given region. The embodiment described below uses “same-day-delivery” as an example of “fast-delivery.” However, in other embodiments, “fast-delivery” may be any other suitable type of delivery as previously discussed.

First, consider a demand distribution density gₖ representing forecast demand in region R, and coefficient αₖ representing a fraction of local customers of item k who are served from local fulfillment center X. In other words, αₖ represents the probability that a unit of item k ordered for delivery in region R will be served from a given node X (under the assumption that item k is available at X). For example, if all orders for delivery in R were assigned to X whenever possible, then αₖ=1, and if all orders for delivery in R except for those selecting “economy” delivery were assigned to X, then αₖ would be the expected fraction of volume in all ship option buckets excluding “economy” delivery. Hence, initial inventory of y units allows the merchant to offer same-day-delivery to the first y/αₖ customers. That is, score S for item k is given by:

$${s}_{k} ( {y}_{k} ) = {\int }_{0}^{{y}_{k} / {α}_{k}} ω {g}_{k} ( ω ) d ω + {\int }_{{y}_{k} / {α}_{k}}^{∞} \frac{{y}_{k}}{{α}_{k}} {g}_{k} ( ω ) d ω \vert \qquad ( 1 )$$

Where yₖ is the inventory target level (i.e., number of units) for item k. The mathematical expectation of total number of same day delivery offers for the set of items is:

$$S ( {y}_{1} , … , {y}_{N} ) = {\sum }_{k = 1}^{N} {s}_{k} ( {y}_{k} ) \vert \qquad ( 2 )$$

And the constraint to be enforced is:

$${\sum }_{k = 1}^{N} {y}_{k} \leq {Y}_{0} \qquad ( 3 )$$

Where Y₀ is a constant, maximum number of inventory units allowed in fulfillment center X. In some embodiments, a solution of equations (2) and (3) may be reached by introducing a Lagrange multiplier λ and seeking a maximum of Lagrangian:

$$\tilde{S} ( {y}_{1} , … , {y}_{N} ) = {\sum }_{k = 1}^{N} {s}_{k} - λ ( {\sum }_{k = 1}^{N} {y}_{k} - {Y}_{0} ) \qquad ( 4 )$$

The first order conditions at extremum (y₁*, . . . y_{N}*) are:

$$\frac{δ \tilde{S}}{δ {y}_{k}} ( {y}_{1}^{*} , … , {y}_{N}^{*} ) = 0. \vert \qquad ( 5 )$$

Hence, the equation to be solved becomes:

$$\frac{δ {s}_{k}}{δ {y}_{k}} ( {y}_{1}^{*} , … , {y}_{N}^{*} ) - λ = 0 \vert \qquad ( 6 )$$

That is:

$$\frac{δ {s}_{k}}{δ {y}_{k}} ( {y}_{1}^{*} , … , {y}_{N}^{*} ) = λ . \vert \qquad ( 7 )$$

Differentiating equation (7) yields:

$$\frac{{y}_{k}^{*}}{{α}_{k}} {g}_{k} ( \frac{{y}_{k}^{*}}{{α}_{k}} ) \frac{1}{{α}_{k}} + {\int }_{{y}_{k}^{*} / {α}_{k}}^{∞} \frac{1}{{α}_{k}} {g}_{k} ( ω ) d ω - \frac{{y}_{k}^{*}}{{α}_{k}} {g}_{k} ( \frac{{y}_{k}^{*}}{{α}_{k}} ) \frac{1}{{α}_{k}} = λ \vert \qquad ( 8 )$$

And, finally:

$${\int }_{{y}_{k}^{*} / {α}_{k}}^{∞} {g}_{k } ( ω ) d ω = λ {α}_{k} \vert \qquad ( 9 )$$

Which may also be expressed as:

$${\int }_{0}^{{y}_{k}^{*} / {α}_{k}} {g}_{k} ( ω ) d ω = 1 - λ {α}_{k} . \qquad ( 10 )$$

Examination of equation (10) indicates that, if all αₖ are equal to 1—i.e., all local customers are assigned to the local fulfillment center,—the model is reduced to a simple in-stock optimization model. Also, if all αₖ are equal to each other, then a fixed critical ratio (CR) solution applies with respect to target yₖ*/αₖ|. More generally, however, equation (10) is not a fixed CR equation, and each target may be defined using appropriately adjusted CR of (1−λαₖ).

The optimization scenario set forth above may be solved by finding the Lagrange system solution to equations (10) and (3). In one embodiment, a method for solving equations (10) and (3) selects λ, calculates yₖ values from first N equations, gets their sum, and compares to Y₀. The process may be organized in a loop that searches for λ until sufficient precision is reached. This method is illustrated in the examples below.

### A First Illustrative Example

As an example, suppose that fulfillment center X will stock 4 items, and that each item has a normal demand distribution in the relevant region defined as follows:

TABLE I

| | Item 1 | Item 2 | Item 3 | Item 4 |
|---|---|---|---|---|
| mean | 240 | 120 | 400 | 20 |
| Standard deviation | 50 | 40 | 100 | 6 |

Further, assume an inventory constraint of Y₀≦1000 combined units, and that all αₖ are equal to 1 (i.e., all local customers are assigned to the local fulfillment center). In this case, an iterative solution may be as follows:

TABLE II

| λ | y1 | y2 | y3 | y4 | sum |
|---|---|---|---|---|---|
| 0.5000 | 240.0 | 120.0 | 400.0 | 20.0 | 780.0 |
| 0.1000 | 304.1 | 171.3 | 528.2 | 27.7 | 1031.2 |
| 0.1400 | 294.0 | 163.2 | 508.0 | 26.5 | 991.7 |
| 0.1200 | 298.7 | 167.0 | 517.5 | 27.0 | 1010.3 |
| 0.1300 | 296.3 | 165.1 | 512.6 | 26.8 | 1000.8 |
| 0.1310 | 296.1 | 164.9 | 512.2 | 26.7 | 999.8 |
| 0.1308 | 296.1 | 164.9 | 512.3 | 26.7 | 1000.0 |

In Table II, each row represents an iteration of the solution of equations (10) and (3). Thus, in the first iteration, λ=0.5, and, in the last iteration, λ=0.1308. The target inventories for each item y₁ through y₄, as well as their sum, evolve through each iteration until the inventory constraint is satisfied to a specified degree of precision. Here, the target inventories are y₁=296.1, y₂=164.9, y₃=512.3, and y₄=26.7. Also, each of these inventory quantities may be further rounded up or down to the next integer number using any suitable rounding mechanism. Moreover, because this example assumes all αₖ=1, the solution is similar to that of a simple stock optimization model.

### A Second Illustrative Example

As another illustrative example, suppose that a fulfillment center has the same 4 items with normal demand distribution defined as follows:

TABLE III

| | Item 1 | Item 2 | Item 3 | Item 4 |
|---|---|---|---|---|
| mean | 240 | 120 | 400 | 20 |
| Standard deviation | 50 | 40 | 100 | 6 |
| α | 0.5 | 0.75 | 0.9 | 1 |

Still assume that inventory constraint Y₀≦1000 combined units, but now each αₖ is different from each other, as shown in Table III above. In this case, a solution may be as follows:

TABLE IV

| λ | y1 | y2 | y3 | y4 | sum |
|---|---|---|---|---|---|
| 0.5000 | 136.9 | 99.6 | 371.3 | 20.0 | 627.7 |
| 0.1000 | 161.1 | 133.2 | 480.7 | 27.7 | 802.7 |
| 0.0100 | 184.4 | 163.0 | 572.9 | 34.0 | 954.2 |
| 0.0020 | 197.3 | 179.0 | 622.0 | 37.3 | 1035.6 |
| 0.0040 | 192.0 | 172.4 | 601.9 | 35.9 | 1002.2 |
| 0.0042 | 191.6 | 172.0 | 600.4 | 35.8 | 999.7 |
| 0.00418 | 191.6 | 172.0 | 600.5 | 35.8 | 1000.0 |

Similarly as the previous example, here each row of Table IV also represents an iteration of the solution of equations (10) and (3). Thus, in the first iteration λ=0.5, and, in the last iteration, λ=0.00418. It may be noted that the target inventories for items y₁ through y₄ are different from the target inventories in the previous example. Specifically, here y₁=191.6, y₂=172, y₃=600.5, and y₄=35.8.

In general, items with low αₖ values are allocated less units then before because they are more “reusable.” For instance, in this example, fulfillment center X does not need to stock as many units of item 1 (compare 191.6 units versus 296.1 units in the previous example) because only a fraction (α₁=0.5) of the expected orders for item 1 are likely to select same-day-delivery offers, and therefore more than one same-day offer can be made for each unit of item 1 that is actually stored in fulfillment center X. Meanwhile, items with high αₖ values are generally allocated more units. For instance, all units of item 4, when offered same day delivery, are expected to be ordered with that delivery option (α₄=1). Therefore, the number of units of item 4 in stock at fulfillment center X is likely to also represent the number of same-day-delivery offers that can be made for that item.

In various embodiments, an optimization, minimization, and/or maximization process may not always guarantee convergence to an absolute solution. For example, an optimization process may exhaustively evaluate a solution space to ensure that the identified solution is the best available. Alternatively, the optimization process may employ heuristic or probabilistic techniques that provide a bounded confidence interval or other measure of the quality of the solution. For example, an optimization process may be designed to produce a solution that is within at least some percentage of an optimal solution, to produce a solution that has some bounded probability of being the optimal solution, or any suitable combination of these or other techniques.

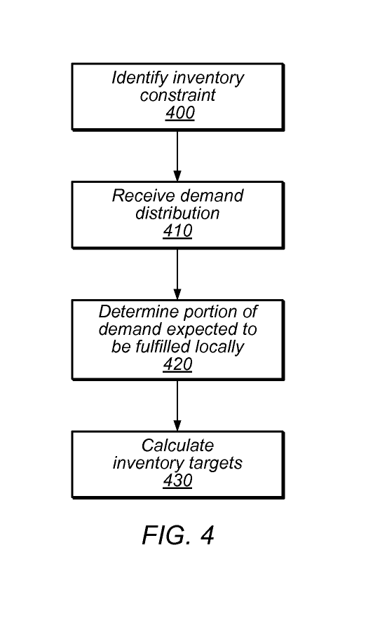

Turning now to FIG. 4, a method for setting inventory levels to increase the expected availability of fast-delivery offers tor customers is depicted according to some embodiments. In some cases, the method of FIG. 4 may be performed by system 200 of FIG. 2 (e.g., planning system 220) for any number of items to be stored in any number of fulfillment centers. Further, the method of FIG. 4 may be repeated periodically and/or in connection with any specified inventory planning period (e.g., once a day, twice a week, 4 times a quarter, etc.).

At block 400, a method may include identifying a total number of units of a plurality of items (Y₀) to be stored in a fulfillment center located within or otherwise assigned to a geographic region. Additionally or alternatively, the total number of units may refer to a cluster of fulfillment centers. At block 410, the method may include receiving an order forecast of expected orders (gₖ) for each of the plurality of items, where the expected orders specify delivery addresses within the geographic region. In some cases, the order forecast may be for a product (i.e., an electronic device, etc.) or for group of products (e.g., a product line, type, category, etc.) The order forecast may be, for instance, a portion of a demand distribution density function for a global region that includes a plurality of geographic regions. At block 420, the method may include determining, for each of the plurality of items, a portion of the expected orders that is expected to be fulfilled by the fulfillment center (αₖ). Additionally or alternatively, the method may determine, for each of item, an aggregate portion of the expected orders that is expected to be fulfilled but a cluster of fulfillment centers. In some embodiments, the portion of the expected orders for at least a given one of the plurality of items is less than all expected orders for the given one of the plurality of items (i.e., at least one of αₖ≦1). In other words, a remainder of the expected orders may be expected to be fulfilled by other fulfillment centers. Additionally, the portion of the expected orders may include orders that are expected to select a given delivery offer and/or it may exclude orders that are expected to select a delivery option slower than the given delivery offer.

At block 430 the method may include calculating based, at least in part, on the total number of units, the order forecast, and the portion of the expected orders, a target inventory of each of the plurality of items for the fulfillment center that increases an expected availability of the given delivery offer to customers of the plurality of items. In some cases, the given delivery offer is designated to be fulfilled by the given fulfillment center and/or the offer cannot be designated for fulfillment by a fulfillment center located outside of the geographic region. In some embodiments, this calculation may be performed, for example, by iteratively seeking a solution to equation (10) that satisfied the constraint in equation (3). For example, the given delivery offer may be a same-day-delivery offer or another suitable type of fast-delivery offer. In other embodiments, calculating target inventories as described herein may maximize the number of same-day-delivery offers available to customers in the geographic region. Once the target inventory level for a particular item is calculated, the merchant may purchase a number of units of that item that causes inventory of the item to approach its corresponding target inventory in the fulfillment center. When the aforementioned calculation is performed for a cluster or group of fulfillment centers, an additional operation may apportion the total inventory target for each of the fulfillment centers of the cluster. Such an apportionment may be performed, for example, to satisfy individual inventory constraints for each fulfillment center.

In some embodiments, any of the methods or techniques described above may be implemented as program instructions and data capable of being stored or conveyed via an article of manufacture including a computer-readable or -accessible medium. Such methods or techniques may include, for example and without limitation, the functions of an order fulfillment system described herein, as well as the method illustrated in FIG. 4 and any suitable variations thereof. Such program instructions may be executed to perform a particular computational function, such as inventory health metric generation and analysis, purchase offer analysis, purchase and/or sales management, operating system functionality, applications, and/or any other suitable functions.

An embodiment of a computer system including computer-accessible media is illustrated in FIG. 5. As illustrated, computer system 500 includes one or more processors 510 coupled to a system memory 520 via an input/output (I/O) interface 530. Computer system 500 further includes a network interface 540 coupled to I/O interface 530. In some embodiments, planning system 220 may be implemented using a single instance of computer system 500, while in other embodiments multiple such systems may be configured to host different portions or instances of a planning system. Moreover, in some embodiments, some data sources or services (e.g., purchasing management services) may be implemented via instances of computer system 500 that are distinct from those instances implementing other data sources or services (e.g., order entry).

In various embodiments computer system 500 may be a single system including one processor 510, or a multiprocessor system including several processors 510 (e.g., two, four, eight, or another suitable number). Processors 510 may be any suitable processor capable of executing instructions. For example, in various embodiments processors 510 may be a general-purpose or embedded processor implementing any of a variety of instruction set architectures (ISAs), such as the x86, PowerPC, SPARC, or MIPS ISAs, or any other suitable ISA. In multiprocessor systems, each of processors 510 may commonly, but not necessarily, implement the same ISA.

System memory 520 may be configured to store instructions and data accessible by process 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above, are shown stored within system memory 520 as code 525.

In one embodiment, I/O interface 530 may be configured to coordinate I/O traffic between processor 510, system memory 520, and any peripheral devices in the device, including network interface 540 or other peripheral interfaces. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network, such as other computer systems, for example. In various embodiments, network interface 540 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

In some embodiments, system memory 520 may be one embodiment of a computer-accessible medium configured to store program instructions and data as described above. However, in other embodiments, program instructions and/or data may be received, sent or stored upon different types of computer-accessible media. Generally speaking, a computer-accessible medium may include storage media or memory media such as magnetic or optical media—e.g., disk or CD/DVD-ROM coupled to computer system 500 via I/O interface 530. A computer-accessible medium may also include any volatile or non-volatile media such as RAM (e.g., SDRAM, DDR SDRAM, RDRAM, SRAM, etc.), ROM, etc, that may be included in some embodiments of computer system 500 as system memory 520 or another type of memory. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 540.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
storing inventory items in a plurality of fulfillment centers in different geographic regions of a fulfillment network; and
performing, by one or more computing devices,
identifying a maximum total number of units of a plurality of items to be stored in the plurality of fulfillment centers located within a geographic region of the regions, wherein at least one other fulfillment center is located outside of the geographic region;
receiving a demand forecast of expected orders for each of the plurality of items, wherein the expected orders are expected to specify delivery addresses within the geographic region, wherein the demand forecast comprises a probability density function of demand for each of the plurality of items within the geographic region, wherein the demand forecast is a portion of a demand distribution density function for the fulfillment network;
determining, for each of the plurality of items and based at least in part on respective order forecasts, a probability value that a unit of an item ordered for delivery within the geographic region will be fulfilled exclusively from a fulfillment center located within the geographic region; and
increasing an expected availability of a particular delivery offer of a plurality of delivery offers to customers of the plurality of items, wherein increasing includes calculating based, at least in part, on: the maximum total number of units, the probability density function of demand, and the probability value, a target inventory of each of the plurality of items for the plurality of fulfillment centers, wherein the particular delivery offer is a type of offer that will be fulfilled exclusively from a fulfillment center located within the geographic region and cannot be designated for fulfillment by the at least one other fulfillment center located outside of the geographic region; and
receiving, by one or more of the plurality of fulfillment centers, inventory in accordance with the calculated target inventory for one or more of the plurality of items from one or more suppliers, and
stocking, by the one or more fulfillment centers, the received inventory for one or more of the plurality of items, wherein stocking the inventory received in accordance with the calculated target inventory actually increases availability of the same-day-delivery offer available to future customers whose orders are expected to specify one or more of the delivery addresses within the geographic region.

2. The method of claim 1, wherein the probability density function of demand for each of the plurality of items within the geographic region comprises a probability density function of demand for a category of products that includes a given item.

3. The method of claim 1, further comprising purchasing, for at least a given one of the plurality of items, a number of units that causes inventory of the given item in the plurality of fulfillment centers to approach a given item's calculated target inventory.

4. The method of claim 1, wherein receiving the demand forecast comprises partitioning a probability density function of demand for a global region that includes at least the geographic region.

5. The method of claim 1, wherein the probability value that a unit of an item ordered for delivery within the geographic region will be fulfilled exclusively from a fulfillment center located within the geographic region is less than a probability value that the unit of the item ordered for delivery within the geographic region will be fulfilled by any fulfillment center.

6. The method of claim 5, wherein the probability value comprises a probability value that a unit of an item ordered for delivery within the geographic region will be selected to be fulfilled via the particular delivery offer.

7. The method of claim 1, wherein the particular delivery offer is a same-day-delivery offer.

8. The method of claim 7, wherein calculating the target inventories to increase the expected availability of the same-day-delivery offer comprises maximizing a number of same-day-delivery offers available to customers in the geographic region.

9. (canceled)

10. (canceled)

11. (canceled)

12. (canceled)

13. (canceled)

14. (canceled)

15. A system, comprising:
a plurality of fulfillment centers in different geographic regions of a fulfillment network;
at least one processor; and
a memory coupled to the at least one processor, wherein the memory stores program instructions, and wherein the program instructions are executable by the at least one processor to:
identify a maximum total number of units of a plurality of items to be stored in the plurality of fulfillment centers located within a geographic region of the geographic regions, wherein at least one other fulfillment center is located outside of the geographic region;
receive, for each of a plurality of items, an order forecast for orders expected to specify delivery addresses within a geographic region of the fulfillment network, wherein the order forecast comprises a probability density function of orders having delivery addresses within the geographic region, wherein the order forecast is a portion of a demand distribution density function for the fulfillment network;
determine, for each of the plurality of items and based at least in part on respective order forecasts, a probability value that a unit of an item ordered for delivery within the geographic region will be fulfilled exclusively from one or more of the plurality of fulfillment centers assigned to the geographic region; and
increase availability of a same-day-delivery offer available to future customers whose orders are expected to specify one or more of the delivery addresses within the geographic region, wherein to increase availability, the program instructions are executable by the at least one processor to:
calculate an inventory amount for each of the plurality of items based, at least in part, on:
the respective probability density function of orders,
the maximum total number of units, and
the respective probability value;
wherein the plurality of fulfillment centers in the geographic region:
receive inventory in accordance with the calculated inventory amount for one or more of the plurality of items from one or more suppliers, and
stock the received inventory for one or more of the plurality of items, wherein stock the inventory received in accordance with the calculated inventory amount increases availability of the same-day-delivery offer available to future customers whose orders are expected to specify one or more of the delivery addresses within the geographic region.

16. The system of claim 15, wherein the same-day-delivery offer is designated to be fulfilled by one of the plurality of fulfillment centers.

17. The system of claim 15, wherein the probability value comprises a probability value that a unit of an item ordered for delivery within the geographic region will be an order for which a same-day delivery option is selected.

18. The system of claim 15, wherein the probability value comprises a probability value that a unit of an item ordered for delivery within the geographic region will be an order for which a delivery option excluding a next-day delivery option, a two-day delivery option, and a ground delivery option is selected.

19. The system of claim 15, further comprising apportioning the calculated inventory for a given one of the plurality of items among the one or more fulfillment centers based, at least in part, on one or more inventory constraints of the one or more fulfillment centers.

20. The system of claim 15, wherein the inventories maximize the availability of the same-day-delivery offer.
